(19) United States
(12) Patent Application Publication
(10) Pub. No.: US 2004/0094642 A1
(43) Pub. Date: May 20, 2004

(54) Crushing method which matches the roll speed to the velocity of the falling material

(76) Inventor: Gary David Everson, Richlands, Queensland (AU)

Correspondence Address: BURNS DOANE SWECKER & MATHIS L L P, POST OFFICE BOX 1404, ALEXANDRIA, VA, 22313-1404, US

(21) Appl. No.: 10/468,053

(22) PCT Filed: Feb. 13, 2002
(86) PCT No.: PCT/AU02/00145

(30) Foreign Application Priority Data
Feb. 13, 2001 (AU) PR 3061

(51) Int. Cl. B02C 4/42

(52) U.S. Cl. 241/30; 241/235

(57) ABSTRACT

A method for reducing fines generated during a crushing operation comprises matching the peripheral roll speed to the drop velocity into the crusher of the material to be crushed. The method is particularly suited to high volume crushing coal where existing techniques result in the generation of a significant level of coal fines (−4 mm).

### FIELD OF THE INVENTION

This invention is directed to a method by which the crushing efficiency of rolls can be improved. The invention is particularly directed to a method which can use existing roll crushers and roll sizers, and which matches or tunes the rotational speed of the rolls with the velocity of the incoming material to improve crushing efficiency and to reduce fines generation. The method finds particular suitability in the mining industry but is not limited thereto.

### BACKGROUND ART

Roll crushers or rolls sizers typically comprise large long cylindrical rolls which are in a parallel configuration and which counter rotate. These devices may comprise opposed pairs of rolls, or an array of opposed pairs of rolls. The rolls have peripheral teeth to draw in the material to be crushed and to assist in the crushing process. The material typically comprises rock, coal, minerals, or any other solid material that is to be crushed. Typically, the material initially passes through a primary crusher that crushes the material into a larger size range. If required, the material is then passed through a secondary or tertiary crusher for fine crushing.

Traditionally, such roll crushers or sizers are of a fixed speed design that is either a high-speed or a lower speed. Speed variation is generally not possible. A typical speed is between 300-350 rpm.

The spacing between the crushing rolls and/or the teeth on the rolls determines the size range of the crushed material. It is highly desirable to ensure that the roll crusher crushes material to within the size range. In practice it is found that the crushers are less efficient and will produce an amount of dust or fines (typically −4 mm particles). This material needs to be kept to a minimum as the dust or fines can be a health hazard, an environmental hazard, and can increase the wear and tear of the roll and the associated machinery.

The crushing rolls should also have a large throughput. It is found that simply increasing the speed of rotation does not always increase the throughput. Instead, an increase in dust or fines is observed and the material to be crushed can sit on top of the rolls rather than being immediately passed between the rolls and crushed. Thus, there is a finite limit to the roll speed after which crushing efficiency is not improved. Of course, it is also possible to increase the throughput by having larger rolls or a greater number of rolls but this increases cost.

Material such as coal etc passes into a crushing roll via a transfer system. The transfer system may comprise a conveyor belt on which the material is transported. The end of the conveyor belt is typically about 1 m above the inlet area of the crushing roll, and the material falls off the conveyor belt and into the crusher roll under the influence of gravity. Thus, the material enters into the crushing roll at a particular velocity. If the vertical distance between the roll and the end of the conveyor belt is sufficient, the material will have a “terminal velocity” of approximately 4.4 m per second.

### OBJECT OF THE INVENTION

The present invention is directed to a method by which existing roll crushers and rolls sizers can have an optimised throughput capacity and a minimised fines generation. This can be achieved by matching the circumferentially velocity of the rolls to the velocity of the material which enters the rolls.

In one form of the invention is directed to a method for crushing a material using rotating rolls, the method comprising the step of passing the material between the rotating rolls to be crushed thereby at a velocity which is substantially the same as the circumferentially velocity (or peripheral speed) of the rolls.

By matching or timing the velocity of the rock, coal or other material to be about the same as the roll speed, it is found that fines generation is minimised. The throughput capacity of the rolls can also be optimised.

While not wishing to be bound by theory, it appears that matching of the velocity is results in a more orderly throughput of material between the rolls. It appears that if the rolls rotate such that the peripheral speed of the rolls is much larger than the entry speed of the material to be crushed, the roll teeth do not efficiently grab the material as the relative rotational speed of the roll teeth is much larger than the entry speed of the material. Put differently, instead of the material being grabbed by a roll tooth and pushed between the rolls, the roll tooth speeds past the material. It is found that this can cause the material to be pushed or shoved or bounced adjacent the inlet between the rolls instead of being efficiently grabbed and crushed between the rolls. Consequently, this action results in much generation of dust and fines.

Conversely, if the peripheral speed of the rolls is much less than the entry speed of the material, it appears that a roll tooth does not immediately grab the material and pass it between the rolls for crushing. Instead, the material can bounce out of the intake area that can cause breakage and fracturing of the material resulting in the generation of dust and fines.

The method maximises the ability for particles which are smaller than the roll set to pass unhindered through the rolls and hence minimise fines generation. If the roll speed is much different to the entry speed of the material, these particles are much more likely to be fractured into a percentage of dust and fines, either by being struck by a roll tooth, or by striking the roll surface or tooth.

The method can use existing roll crushers and sizers and therefore does not require the manufacture of any specially designed crusher or sizer, or any major modifications. It is only necessary to adjust the rotational speed to match the velocity of the material being dropped into the intake area of the crusher.

Typically, the material to be crushed is conveyed to the crusher by a feeder of sorts. This may include conveyors and belt feeders, reciprocating feeders, vibrating feeders, apron feeders, chain/flight feeders, single and multi slope vibrating screens, a static grizzly, roll screens or a feeder breaker. Each of these devices will feed the material to the crusher at a different speed. Therefore, the roll speed will need to take into account the type of feeding device which feeds the material between the rolls. The roll speed will also need to take into account any gravity effect on the material. For instance, for secondary and tertiary crushers, there is typically a drop height of between 2-3 m.

In practice, for a particular type of feeding device, the speed of the material can be measured just before entry into the crusher or sizer, and the roll velocity can be adjusted such that the circumferentially velocity of the rolls approximates the velocity of the material as it enters between the rolls.

### BEST MODE

A twin drum tooth roll crusher used by the coal industry was tested. The drum typically has a length of between 1-3 m and a diameter of between 30-100 cm. In the particular example, the diameter of each roll shell was 534 mm.

Coal was collected from a coal stockpile and transported on a conveyor belt to the crusher. The vertical distance between the conveyor discharge and the center line of the crusher was 988 mm. The particle velocity at the center line of the crusher was measured at 4.4 m per second.

Initially, the crusher speed was set at 183 RPM and the amount of coal passing through the crusher was varied. 6 tests were carried out and the results are given in table 1. For the purpose of the example, fines were considered to be coal particles of −4 mm. The Feed was the coal on the conveyor belt passing into the crusher, and the Product was the crushed coal passing through the crusher.

TABLE 1

| | | | | | Crusher |
|---|---|---|---|---|---|
| | Fine % in | Fine % in | % increase in | Feed rate | Speed |
| Test | Feed | Product | Fines | (tph) | RPM |
| 1 | 17.9 | 21.0 | 3.1 | 475 | 183 |
| 2 | 24.1 | 26.0 | 2.0 | 532 | 183 |
| 3 | 20.7 | 21.3 | 0.6 | 498 | 183 |
| 4 | 22.7 | 26.7 | 3.9 | 527 | 183 |
| 5 | 21.2 | 23.7 | 2.5 | 521 | 183 |
| 6 | 21.6 | 24.6 | 3.0 | 524 | 183 |

The table demonstrates that as a constant crusher speed, the average increase in the percentage of fines is about 2% as the coal is crushed. It is however expected that if the feed rate is greatly increased, the percentage of fines will increase.

Table 2 illustrates the effect of roll speed on the generation of fine coal (−4 mm). For the purpose of this example, the vertical distance between the conveyor discharge and the center line of the crusher was 988 mm. Therefore the particle velocity at the center line of the crusher was 4.4 m/s.

To match the crusher peripheral speed on the shell with the particle velocity, a roll speed of 157 RPM is required.

TABLE 2

| | | | | | Crusher |
|---|---|---|---|---|---|
| | Fine % in | Fine % in | % increase in | Feed rate | Speed |
| Test | Feed | Product | Fines | (tph) | RPM |
| 7 | 20.6 | 23.5 | 3.0 | 448 | 154 |
| 8 | 19.8 | 20.6 | 0.8 | 481 | 169 |
| 9 | 20.3 | 23.4 | 3.1 | 514 | 169 |
| 10 | 20.5 | 26.9 | 6.5 | 517 | 227 |
| 11 | 11.7 | 23.5 | 11.8 | 324 | 99 |

The variable speed tests illustrated in Table 2 demonstrates that an optimum speed of 175 RPM exists to minimise fines generation to approximately 2.2%. This speed is comparable to the theoretical optimum speed of 157 RPM. The low speed test (99 RPM) and the high-speed test (227 RPM) produced significantly increased fines generation. Test 11 (the low speed test) also included a reduced feed rate to minimise the possibility of fines generation being due to feeding too much material into the crusher, but even at the reduced feed rate, the percentage of fines was much higher than when the speed of the rolls was matched with the velocity of the coal falling into the crusher.

It appears that the matching of the roll and material velocity to about 10% from the theoretical rate results in:

1. Maximising the opportunity for the rolls to grab particles larger than the set (the gap between the rolls) of the rolls. This optimises throughput capacity and minimises fines generation by not allowing particles to bounce of the rolls all sit on top of the rolls.

2. Maximising the opportunity for particles, smaller than the roll set, to pass unhindered through the rolls and hence minimise fines generation.

It should be appreciated that various changes and modifications can be made to the embodiment described without departing from the spirit and scope of the invention.

1. A method of crushing material using counter rotating crushing rolls, the method comprising passing material to be crushed into the crushing rolls at a particular velocity, and having the peripheral speed of the rolls approximating the particular velocity of the material passing into the crushing rolls.

2. The method as claimed in claim 1, wherein the material comprises coal.

3. The method as claimed in claim 1, wherein the material is dropped under the influence of gravity into the crushing rolls.

4. The method as claimed in claim 3, wherein the roll is a twin drum tooth roll crusher which has a length of between 1-3 m and a diameter of between 30-100 cm.

5. The method of claim 1, wherein the peripheral speed of the rolls in within 10% of the particular velocity.
